(19) United States
(12) Patent Application Publication
(10) Pub. No.: US 2025/0062045 A1
(43) Pub. Date: Feb. 20, 2025

(54) METHOD FOR TREATING RADIOACTIVE WASTE GLASS FIBERS

(71) Applicant: KOREA HYDRO & NUCLEAR POWER CO., LTD, Gyeongju-si Gyeongsangbuk-do (KR)

(72) Inventors: Young Hwan HWANG, Daejeon (KR); Mi Hyun LEE, Daejeon (KR); Cheon Woo KIM, Daejeon (KR); Ji Soo YOON, Daejeon (KR)

(73) Assignee: KOREA HYDRO & NUCLEAR POWER CO., LTD, Gyeongju-si Gyeongsangbuk-do (KR)

(21) Appl. No.: 18/721,026

(22) PCT Filed: Jan. 2, 2023
(86) PCT No.: PCT/KR2023/000032

§ 371 Date: Jun. 17, 2024

(30) Foreign Application Priority Data
Jan. 4, 2022 (KR) 10-2022-0000760

(51) Int. Cl. G21F 9/30

(52) U.S. Cl. CPC G21F 9/30

(57) ABSTRACT

Provided is a method of treating radioactive waste glass fiber. The method of treating the radioactive waste glass fiber includes: preparing the radioactive waste glass fiber: loading the radioactive waste glass fiber into a canister; heat-treating the canister under set conditions through a heat treatment unit; and transferring the radioactive waste glass fiber whose volume has been reduced through the heat treatment.

### TECHNICAL FIELD

The present disclosure relates to a method of treating radioactive waste glass fiber.

### BACKGROUND ART

Nuclear power plants use glass fiber-based insulation to insulate major piping and high-temperature equipment and protect workers. In particular, a large amount of glass fiber insulation is used to insulate and block piping and equipment around steam generators. Glass fibers are currently prepared for disposal by loading the glass fibers into drums (e.g. 200L, etc.) and compressing them with manpower. In this process, the glass fibers are broken into small pieces and meet dispersibility requirements, making them unsuitable for disposal. Accordingly, additional processing is required.

### DISCLOSURE

### Technical Problem

Aspects of the present disclosure are to increase the ease of disposal of glass fiber insulation in view of the fact that most of the glass fiber insulation can be classified as ultra-low level or self-disposal waste because the glass fiber insulation has a large volume compared to its mass and an insignificant contamination level.

Aspects of the present disclosure are also to greatly contribute to the disposal or deregulation of radioactive waste through a heat treatment process and a subsequent treatment process on glass fiber insulation.

Aspects of the present disclosure are also to reduce a volume reduction ratio of glass fiber insulation to ultimately reduce the cost of radioactive waste disposal.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

### Technical Solution

According to an aspect of the present disclosure, there is provided a method of treating radioactive waste glass fiber. The method includes: preparing the radioactive waste glass fiber; loading the radioactive waste glass fiber into a canister; heat-treating the canister under set conditions through a heat treatment unit; and transferring the radioactive waste glass fiber whose volume has been reduced through the heat treatment.

In addition, the canister includes a first lower canister and a first upper canister which can be attached to and detached from the first lower canister and repeatedly receives the radioactive waste glass fiber based on the attachment and the detachment to repeatedly perform the heat treatment.

In addition, the glass fiber whose volume has been reduced is accommodated in a transfer unit for external transfer while being accommodated in the first lower canister, and the first lower canister, a second lower canister separate from the first lower canister and a third lower canister separate from the first lower canister are placed adjacent to each other inside the transfer unit.

In addition, the first lower canister, the second lower canister and the third lower canister are stacked on each other in a horizontal direction or a vertical direction, protruding structures are formed at the top or bottom of the first lower canister through the third lower canister, and fitting portions corresponding to the protruding structures are formed at the top or bottom of the first lower canister through the third lower canister and fitted and fixed to the protruding structures.

In addition, the degree of volume reduction of the radioactive waste glass fiber in the canister due to the heat treatment is determined through a laser level measurement module, and the first lower canister is separated from the first upper canister when the degree of volume reduction satisfies a preset standard.

In addition, the temperature condition of the radioactive waste glass fiber in the canister is determined through a thermocouple, and the first lower canister is separated from the first upper canister when the temperature condition as well as the degree of volume reduction satisfies a preset standard.

In addition, the first lower canister and the first upper canister are provided to be attachable to and detachable from each other to allow the radioactive waste glass fiber to be fed and discharged.

In addition, the canister and the heat treatment unit are located in a space where an air conditioner is installed, the heat treatment of the radioactive waste is performed in the space, and a product generated through the heat treatment is discharged through the air conditioner.

### Advantageous Effects

A method of treating radioactive waste glass fiber according to the present disclosure provides at least one of the following advantages.

The present disclosure can increase the ease of disposal of glass fiber insulation in view of the fact that most of the glass fiber insulation can be classified as ultra-low level or self-disposal waste because the glass fiber insulation has a large volume compared to its mass and an insignificant contamination level.

In particular, it is possible to greatly contribute to the disposal or deregulation of radioactive waste through a heat treatment process and a subsequent treatment process on the glass fiber insulation.

In addition, it is possible to reduce a volume reduction ratio of the glass fiber insulation to ultimately reduce the cost of radioactive waste disposal.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

### DESCRIPTION OF DRAWINGS

FIG. 1 is a flowchart sequentially illustrating a method of treating radioactive waste glass fiber according to an embodiment of the present disclosure;

FIGS. 2 through 4 are diagrams illustrating components according to FIG. 1; and

FIGS. 5 through 12 are pictures showing states of glass fiber processed according to FIG. 1.

### MODE FOR INVENTION

Hereinafter, exemplary embodiments of the present disclosure will be described in further detail with reference to the attached drawings. Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the present disclosure to those skilled in the art, and the present disclosure will only be defined by the appended claims. Like reference numerals refer to like elements throughout the specification.

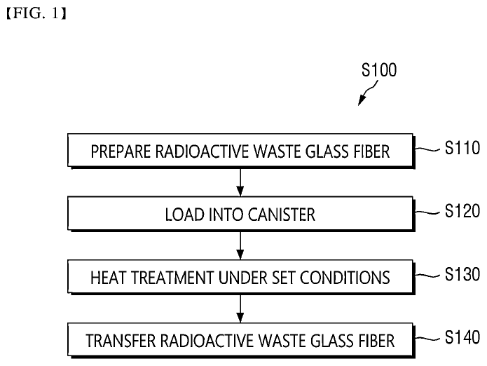

Referring to FIG. 1, in a method of treating radioactive waste glass fiber O according to an embodiment of the present disclosure, first, the radioactive waste glass fiber O is prepared. In addition, the radioactive waste glass fiber O is loaded into a canister 110.

Here, the canister 110 is heat-treated under set conditions through a heat treatment unit. The radioactive waste glass fiber O whose volume has been reduced through the heat treatment is transferred.

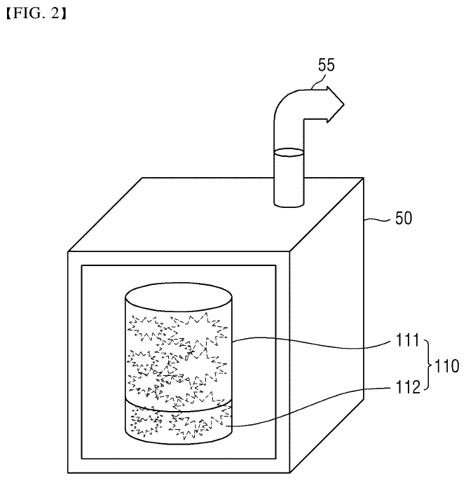

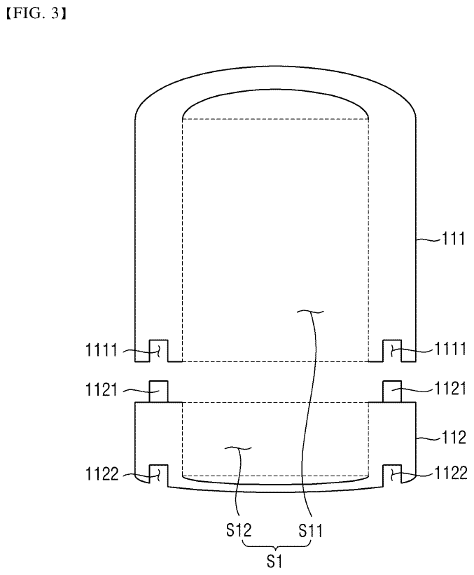

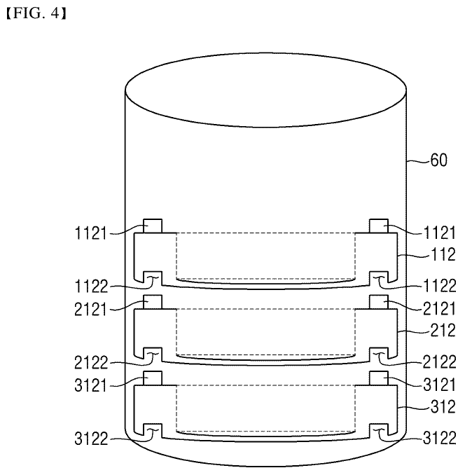

Referring to FIGS. 2 through 4, the canister 110 includes a first lower canister 112 and a first upper canister 111. The first upper canister 111 of the canister 110 can be attached to and detached from the first lower canister 112.

The first lower canister 112 and the first upper canister 111 repeatedly receive the radioactive waste glass fiber O based on the attachment and the detachment to repeatedly perform the heat treatment.

The glass fiber O whose volume has been reduced is accommodated in a transfer unit 60 for external transfer while being accommodated in the first lower canister 112. The first lower canister 112 and a second lower canister 212 separate from the first lower canister 112 are placed adjacent to each other inside the transfer unit 60.

In addition, the first lower canister 112, the second lower canister 212 separate from the first lower canister 112, and a third lower canister 312 separate from the first lower canister 112 can be placed adjacent to each other inside the transfer unit 60.

That is, although a case where the first lower canister 112 through the third lower canister 312 are placed together is disclosed, this is only an example, and the number of lower canisters can be increased within limits.

The first lower canister 112, the second lower canister 212, and the third lower canister 312 are stacked on each other in a horizontal direction or a vertical direction. Protruding structures 1121, 2121 and 3121 are formed at the top or bottom of the first lower canister 112 through the third lower canister 312.

Here, fitting portions 1122, 2122 and 3122 corresponding to the protruding structures 1121, 2121 and 3121 may be formed at the top or bottom of the first lower canister 112 through the third lower canister 312 and may be fitted and fixed to the protruding structures 1121, 2121 and 3121.

The degree of volume reduction of the radioactive waste glass fiber O in the canister 110 due to the heat treatment is determined through a laser level measurement module (not illustrated). When the degree of volume reduction satisfies a preset standard, the first lower canister 112 is separated from the first upper canister 111.

In addition, the temperature condition of the radioactive waste glass fiber O in the canister 110 is determined through a thermocouple (not illustrated). When the temperature condition of the radioactive waste glass fiber O as well as the degree of volume reduction satisfies a preset standard, the first lower canister 112 is separated from the first upper canister 111.

The first lower canister 112 and the first upper canister 111 described above are basically provided such that they can be attached to and detached from each other to allow the radioactive waste glass fiber O to be fed and discharged.

The canister 110 and the heat treatment unit are located in a space where an air conditioner is installed. The canister 110 and the heat treatment unit perform the heat treatment of the radioactive waste in the space. In addition, a product generated through the heat treatment is discharged through the air conditioner.

The glass fiber O was heat-treated under the conditions shown in Table 1 below.

TABLE 1

| | Weight | Volume | | Weight | Volume |
|---|---|---|---|---|---|
| | before | before | Processing | after | after |
| | processing | pro- | temperature | processing | pro- |
| Embodiment | (g) | cessing | (° C.) | (g) | cessing |
| Embodiment 1 | 312.2 | Large | 800 | 12.1 | Small |
| Embodiment 2 | 339.1 | Large | 900 | 38.8 | Small |
| Embodiment 3 | 318.5 | Large | 700 | 18.2 | Small |
| Embodiment 4 | 289.5. | Large | 1,200 | 89.5 | Small |

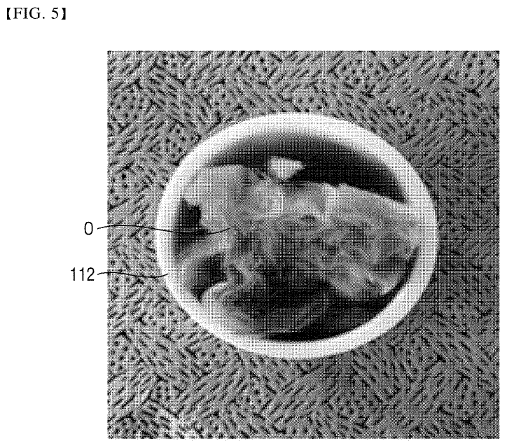

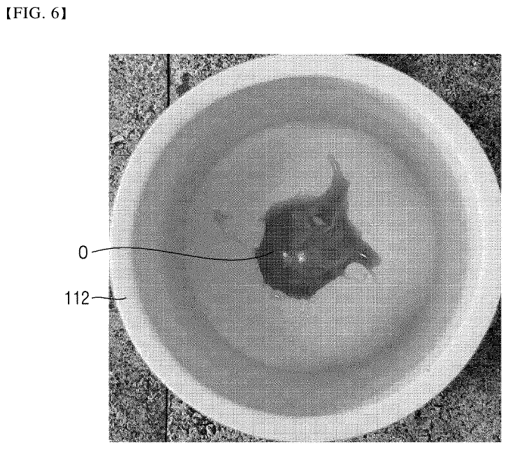

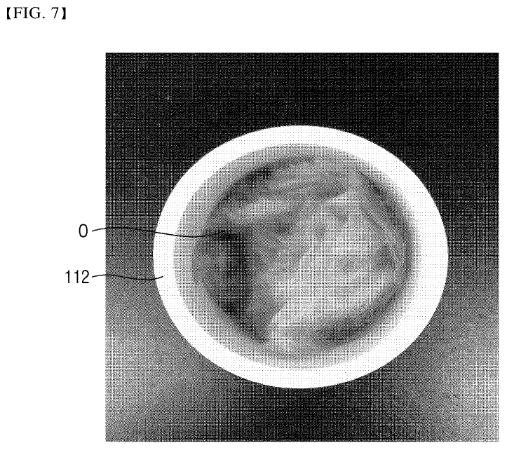

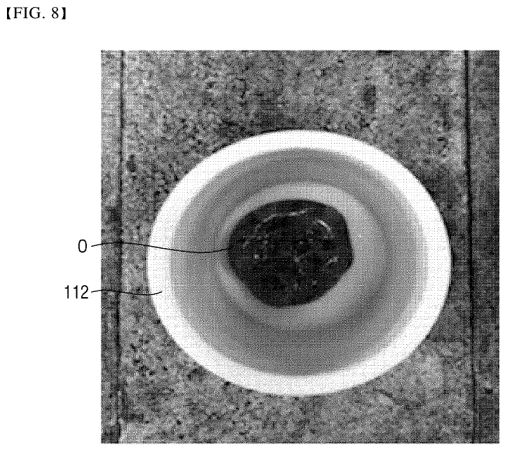

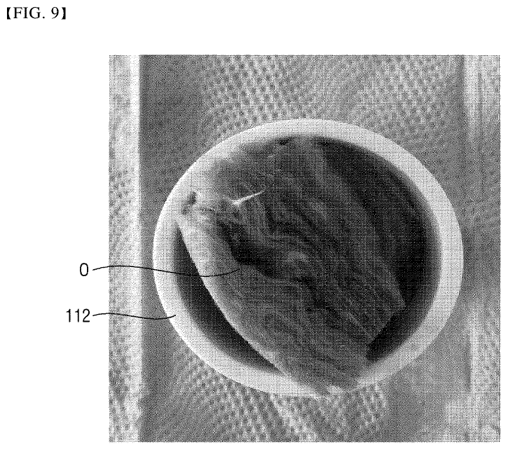

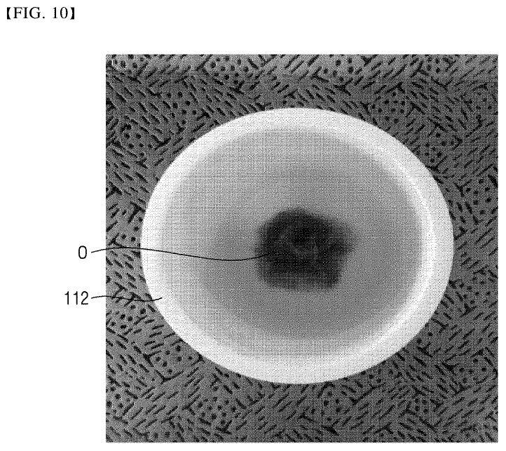

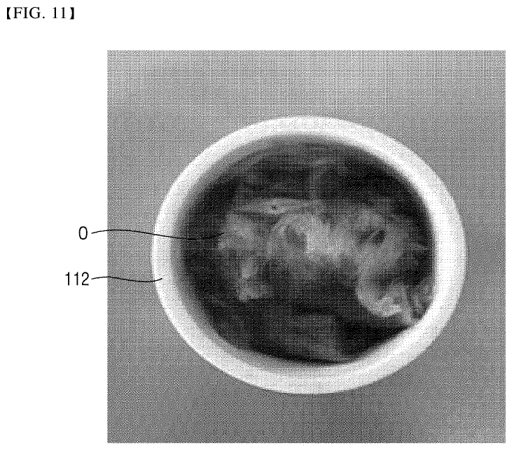

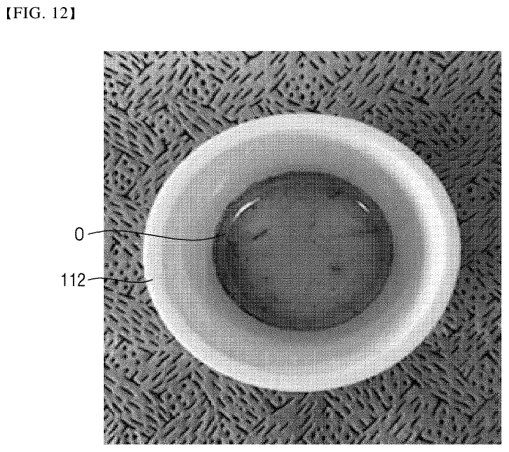

According to Embodiment 1, it can be seen that the glass fiber O before processing and the glass fiber O after processing changed from the state of FIG. 5 before processing to the state of FIG. 6 after processing. According to Embodiment 2, it can be seen that the glass fiber O before processing and the glass fiber O after processing changed from the state of FIG. 7 before processing to the state of FIG. 8 after processing. According to Embodiment 3, it can be seen that the glass fiber O before processing and the glass fiber O after processing changed from the state of FIG. 9 before processing to the state of FIG. 10 after processing. According to Embodiment 4, it can be seen that the glass fiber O before processing and the glass fiber O after processing changed from the state of FIG. 11 before processing to the state of FIG. 12 after processing.

Although the glass fiber O has a large volume compared to its mass, the above-described processing can reduce the volume, increase ease of disposal, and promote lifting of regulations related to radioactive waste disposal. In addition, since a volume reduction ratio increases, the cost of radioactive waste disposal can be reduced.

While the present disclosure has been particularly illustrated and described with reference to exemplary embodiments thereof, it will be understood by those of ordinary skill in the art that various changes in form and detail may be made therein without departing from the spirit and scope of the present disclosure as defined by the following claims. The exemplary embodiments should be considered in a descriptive sense only and not for purposes of limitation.

1. A method of treating radioactive waste glass fiber, the method comprising:
preparing the radioactive waste glass fiber;
loading the radioactive waste glass fiber into a canister;
heat-treating the canister under set conditions through a heat treatment unit; and
transferring the radioactive waste glass fiber whose volume has been reduced through the heat treatment.

2. The method of claim 1, wherein the canister comprises a first lower canister and a first upper canister which can be attached to and detached from the first lower canister and repeatedly receives the radioactive waste glass fiber based on the attachment and the detachment to repeatedly perform the heat treatment.

3. The method of claim 2, wherein the glass fiber whose volume has been reduced is accommodated in a transfer unit for external transfer while being accommodated in the first lower canister, and the first lower canister, a second lower canister separate from the first lower canister and a third lower canister separate from the first lower canister are placed adjacent to each other inside the transfer unit.

4. The method of claim 3, wherein the first lower canister, the second lower canister and the third lower canister are stacked on each other in a horizontal direction or a vertical direction, protruding structures are formed at the top or bottom of the first lower canister through the third lower canister, and fitting portions corresponding to the protruding structures are formed at the top or bottom of the first lower canister through the third lower canister and fitted and fixed to the protruding structures.

5. The method of claim 2, wherein the degree of volume reduction of the radioactive waste glass fiber in the canister due to the heat treatment is determined through a laser level measurement module, and the first lower canister is separated from the first upper canister when the degree of volume reduction satisfies a preset standard.

6. The method of claim 5, wherein the temperature condition of the radioactive waste glass fiber in the canister is determined through a thermocouple, and the first lower canister is separated from the first upper canister when the temperature condition as well as the degree of volume reduction satisfies a preset standard.

7. The method of claim 2, wherein the first lower canister and the first upper canister are provided to be attachable to and detachable from each other to allow the radioactive waste glass fiber to be fed and discharged.

8. The method of claim 1, wherein the canister and the heat treatment unit are located in a space where an air conditioner is installed, the heat treatment of the radioactive waste is performed in the space, and a product generated through the heat treatment is discharged through the air conditioner.
